(19) United States
(12) Patent Application Publication
(10) Pub. No.: US 2015/0339713 A1
(43) Pub. Date: Nov. 26, 2015

(54) SYSTEM AND DEVICE FOR MANAGING MULTIPLE CONVERSATIONS

(71) Applicants: Laurence S. Ross, Oldwick, NJ (US); James Caruso, Chester, NJ (US)

(72) Inventors: Laurence S. Ross, Oldwick, NJ (US); James Caruso, Chester, NJ (US)

(73) Assignee: LSR TECHNOLOGIES, LLC, Oldwick, NJ (US)

(21) Appl. No.: 14/816,421

(22) Filed: Aug. 3, 2015

Related U.S. Application Data
(63) Continuation of application No. 14/487,299, filed on Sep. 16, 2014.
(60) Provisional application No. 61/878,077, filed on Sep. 16, 2013.

(51) Int. Cl. G06Q 30/02; H04L 12/58

(52) U.S. Cl. CPC G06Q 30/0255; G06Q 30/0277; H04L 51/046

(57) ABSTRACT

A system, method, and device for managing multiple tasks, or conversations, is disclosed. A user interface allows the user to collect and create shared conversations on any number of topics and organize those conversations on a single page. As conversations persist, more information is provided by the plurality of users using the platform, and the user gains information via the conversations he/she chooses to follow. Each conversation is further associated with direct purchasing options, which are suggested to the user based on the common terms within that conversation as well as the common terms associated with the collection of that particular user's managed conversations.

### PRIORITY AND RELATED APPLICATION

This application claims priority to U.S. Provisional Patent Application Ser. No. 61/878,077, filed Sep. 16, 2013, entitled SYSTEM AND DEVICE FOR MANAGING MULTIPLE CONVERSATIONS, which is hereby incorporated by reference in its entirety. This application also utilizes and incorporates fully by reference the disclosures in U.S. Pat. Nos. 7,424,471, 8,239,401, and 8,161,064.

### FIELD OF THE INVENTION

The present invention relates to systems and devices for information presentation and organization on a computer display, and particularly to the simultaneous display of related data from a plurality of sources in a single window.

### BACKGROUND OF THE INVENTION

In the current state of the art, switching the window display presentation between browsers and their web resources has become easier and occurs faster due to the introduction of multiple tabs in window browsers. In such configurations, a user can create various tabs associated with an active browser, thus organizing the browser-accessed content on the device window in an easily accessible fashion (by switching between tabs). The user can manually browse and configure multiple windows to fit on the same device display and view multiple activated web resources with each active browser in its own window.

This manual process of browsing and configuring multiple windows, however, is currently slow, inefficient, and inconvenient. Consequently, there exists a need to enable a faster, easier, more efficient, and more convenient manner of activating and presenting multiple tasks and web content simultaneously on computer displays. There is also a need to couple such multiple task management with the option to perform an action, such as a purchase, determined from the information obtained via the multiple task management. Current systems allow for tabbing processes in order to be able to separate and manage multiple pages, but when a user finds the information he/she is looking for, the user must open yet another tab or window or browser in order to act upon that information.

Consequently, there is a need to improve the current art's slow and repetitive manual input requirements by systems and devices which ease, improve, automate, and even suggest additional tasks for the simultaneous presentation of related information in a single window.

There is also a need to provide means for automating the manual opening of and typing within multiple browsers, as well as the manual transfer of information and information parameters between browsers.

There is also a need to create groups of linked browsers with user-arranged linking configurations for commonly used applications as well easy adaptation by less sophisticated users. There is also a need to enable users to save and retrieve a variety of prearranged linked group configurations that suit individual needs, accessible on the user's individual computer devices.

### SUMMARY OF THE INVENTION

Disclosed herein is a system for managing data and linking conversations to purchase options using common terms, comprising processing units configured to collect conversations among various users in the form of online posts, assign one or more common terms to each conversation, display user-chosen conversations in a single workspace, maintain a list of user-specific common terms, and associate purchase options with each conversation, where the purchase options are based on the common terms assigned to the conversation, presented to a user, and directly accessible by the user through the same workspace.

In some aspects, the system further comprises one or more processing units configured to form a new conversation sourced from an off topic user post to an existing conversation.

In some aspects, the purchase options are presented to the user in an order of relevancy based on a combination of common terms associated with the conversations a user has in his/her workspace. In some aspects, the order of relevancy is further based on the user's manually input preferences.

In some aspects, the system is moderated by a human. In other aspects, the system is moderated without human intervention.

In some aspects, user-chosen conversations may be located via browsing. In other aspects, user-chosen conversations may be located via character searching.

In some aspects, purchase options comprise proprietary contact information. In some aspects, purchase options comprise goods and/or services.

In some aspects, the system further comprises one or more processing units configured to create a new conversation and perform a similarity check (if a user cannot find what he/she is looking for via searching or browsing).

In some aspects, conversations may be grouped based on common terms.

In some aspects, the system further comprises one or more processing units configured to suggest conversations to a user based on a combination of common terms associated with the user's workspace.

In some aspects, each post may be rated based on its veracity.

In some aspects, one or more conversations may be collapsed into one or more tabs within the workspace.

Also disclosed herein is a system for managing multiple conversations, comprising a user interface for displaying all conversations from one or more conversation databases, where the user interface further comprises a workspace for organizing user-chosen conversations, wherein each user-chosen conversation is labeled with one or more common terms within the user-chosen conversation, the common terms forming one or more tags. The system further comprises a tag database for storing one or more common terms associated with a particular conversation, the tag database further comprising one or more purchase option datasets based on an individual tag and associated with a particular conversation. Then, the user interface, upon a user's initiation, further displays a list of purchase options compiled from the tag database and associated with the tags of a user-chosen conversation. In some aspects, the user interface groups user-chosen conversations by level of importance to a user. In some aspects, the user interface further comprises one or more unlock buttons for displaying the list of purchase options.

Also disclosed herein is a social network method for managing multiple datasets and offering purchase options to a user, comprising, identifying one or more common terms within each dataset stored in a database, creating an association between those terms and the dataset, performing a search through a purchase database to identify purchase options for a particular dataset based on the dataset's associated common terms, linking those purchase options with the particular dataset, displaying to a user all existing datasets, wherein the user chooses one or more datasets to follow and interact with, relocating one or more user-chosen datasets into a reorganizable workspace where the user can manage and move the datasets according to personal preference, and providing the user, upon user request, with a plurality of purchase options linked with each user-chosen dataset.

### BRIEF DESCRIPTION OF THE DRAWINGS

FIG. 1 is an example screenshot of the graphical user interface for managing conversations according to the present invention.

FIG. 2 is an example screenshot of the graphical user interface for making purchases according to the present invention.

FIG. 3 is a flowchart detailing the process for adding a task to the workstation according to the present invention.

FIG. 4 is a flowchart detailing the process for branching according the present invention.

FIG. 5 is a flowchart detailing the process for suggesting purchase options for a task based on the tag system according to the present invention.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The disclosure relates to establishing a social network of users so that users can learn new information about a given industry (e.g., advertising, real estate, etc.) via message boards referred to herein as “conversations.” The network utilizes information from a user's particular workspace and other profile data to effectively “recommend” purchase options (e.g., contact information, goods, services, etc.) for the user. In one example, the common terms found in a user's workspace, referred to herein as “tags,” are obtained by the system to identify a user's particular interests. The list of tags associated with each user profile may be automatically obtained by the network, manually uploaded by a user, or by any other suitable process for obtaining and identifying common terms within each conversation within a user's workspace. A user may select and manage which conversations to include in their workspace, thus allowing the network to form an individual list of tags associated with that user's profile.

The present invention combines the functions of providing updated news, collected and organized by topic, displaying and managing multiple conversations at once, and allowing for the purchase of private or otherwise helpful information based on the conversations a user collects as well as other personal user preferences. These functions, as described in detail below, are performed and available simultaneously and on a single page, making an individual user's search for information simpler and fully manageable, from start to finish, using a single dynamic screen.

Methods of Communication Among Databases

The following describes one example in which a user terminal may communicate with a conversation database and a tag database in order to provide the user with individualized purchase options. The user terminal may comprise a mobile device, personal computer, laptop, tablet, or other suitable device for accessing and displaying information from a conversation database, news database, or similar interface. The user terminal communicates with the conversation database and the tag database to transmit and receive information from the conversation database and the tag database. Likewise, the conversation database communicates with the tag database to transmit and receive information from the tag database. Similarly, the tag database transmits and receives information to and from the user terminal and conversation database. The user terminal, conversation database, and the tag database communicate with each other over a mobile network, the Internet, one or more intranets, or a combination thereof. In one example, the user terminal communicates via a mobile network which connects to other networks supporting the conversation database and the tag database, and the conversation database and tag database communicate with each other over one or more Intranets. The user terminal may communicate directly with a conversation database and the tag database, or it may communicate indirectly with the tag database via the conversation database. The conversation database may communicate directly to both the user terminal and the tag database. The tag database may communicate directly with the conversation database, directly with the user terminal, or indirectly with the user terminal via the conversation database.

The user terminal may take the form of a website, intranet site, mobile network site, or other suitable interface for displaying, interacting with, and allowing a user to manage conversations and/or purchase information, products, services, etc. The conversation database and/or the tag database may comprise a plurality of sites or interfaces in communication with each other. Each site may run on one server or a group of servers accessible via communication network. The tag database may also include a tag catalogue that manages the tag database (such that specific purchase options are consistently associated with particular tagging terms). The tag catalogue stores the product information and various other information and processes that are utilized by the tag database to offer, via the user interface, various products, services, accessories, and contacts, including downloadable products, to a user. In one example, the tag database may link to a website or other suitable interface where users shop for a particularly suggested purchase option. In another example, the user terminals may include software or programming to access the tag database, including the associated purchase options, and display information received therefrom (without linking to another website).

The User Workstation and Management of Tasks

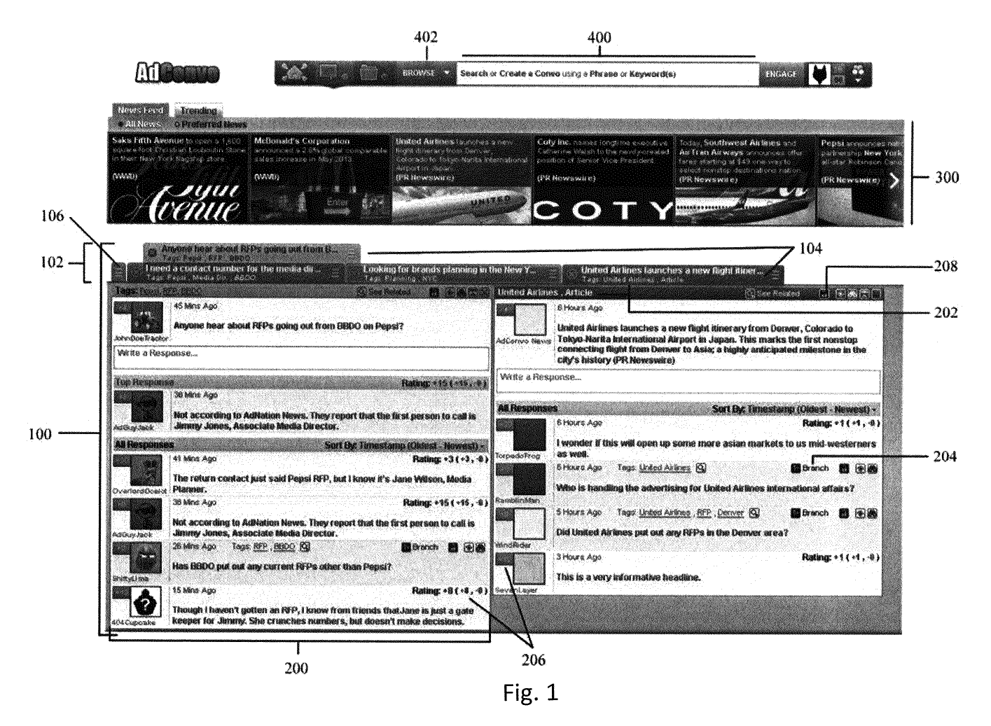

The numeric references made throughout this disclosure refer to the elements marked in FIG. 1, unless otherwise specified.

The present invention discloses a system, method, and device, implementable using any communication network, for creating a dockable workspace for simultaneously displaying and managing multiple tasks 200 (conversations which are added to the workstation are termed as “tasks”; with reference to the windows within the workstation, “tasks” and “conversations” are used interchangeably herein; neither term, however, is meant to limit the utility of the present invention, which comprises the sharing and managing of any type of data or dataset). Tasks 200 may be rearranged and prioritized within the workspace by a user based on the user's individual preferences. The user-specific workspace in which the tasks 200 may be combined, organized, prioritized, and interacted with, is hereinafter referred to as the workstation 100. The workstation 100 stores tasks which are of interest to a user. It should further be noted that the use of the term “conversation” is not meant to limit the present invention to management of conversations or human conversations. Ultimately, the present disclosure regards the ability to post, read, and manage data and/or sets of data. Technically, as long as such data falls into the categories of sourced information or user input (as defined herein), it is acceptable within the system. It is not limited to users posting quotes or links or any other individual source for data. No third party or entity needs to exist for the system to operate, although a possible third entity could act similar to a Trojan, which is essentially a tampering bug adding information. This platform could, for example, be used for users to post fan-made works of fiction, art, photos, etc. The content of the posts and what the user does with it is essentially irrelevant. The system simply offers users the tools and options to share information and opinions. Thus, the conversations allow users to gather, share, teach, and learn information (i.e. data). A user might utilize such data, for example, to predict trends in various markets using keywords and common terms.

Furthermore, any conversation may become a project among collaborating users. By way of example, the management system disclosed herein could be utilized to form a list for requirements for a construction project. Interacting users comprising both peers and professionals may collaborate via one or more tasks, sharing goals and creative ideas and eventually leading to educated purchases and the achievement of certain shared goals.

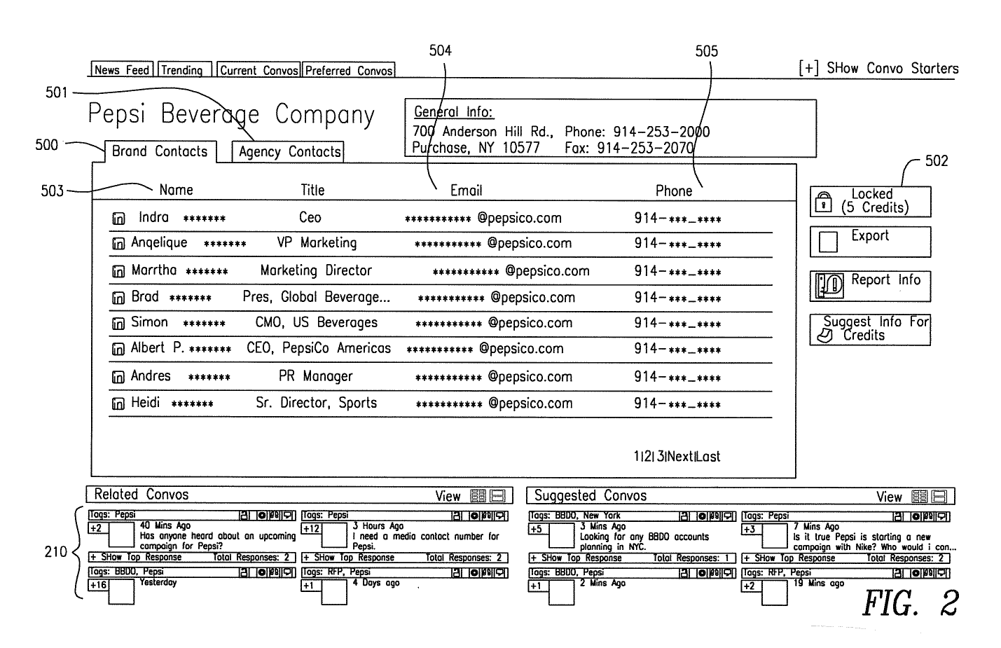

The workstation is capable of displaying, or organizing, tasks in a variety of manners based on user preference. In one embodiment, as depicted in the screenshot of FIG. 1, the workstation shows a task in an open view (i.e. in large format) on the left side of the workstation. In this embodiment, the left-hand slot remains the largest, and the user may drag any new or existing task to the left-hand slot to enlarge it, while moving and/or shrinking the previously enlarged conversation. In the same embodiment, the right side of the workstation may contain a second task in a similar open view, potentially shrunk down in size, again based on user preference. Alternatively, the right side of the workstation may comprise any number of tasks, sized and organized in any manner comfortable to the user, as well as a mini-view 210 of various tasks which the user has added to his/her workstation (See FIG. 2). A mini-view is a compact view displaying the essential aspects of a conversation, including but not limited to the user information, subject, header, and response bar. The response bar shows the number of responses and upon click, expands to reveal the conversation's top rated response. Additionally, any mini-view window may be expanded into a fully open task for user interaction. In FIG. 2, the mini-view 210 is utilized to show additional related conversations that a user may choose to add to the workstation. It should be noted, however, that the mini-view is not limited to displaying related conversations and may be employed to display any set of conversations outside the workstation and/or tasks within the workstation. There is no limit to the amount of open conversations allowed on a workstation screen. Horizontal or vertical scrolling works in a manner similar to known methods in the art today or the news feed scrolling mechanism, described further herein. An open conversation may also be collapsed into its tab 104 (see description of tabs and the dock, further below) in order to reduce clutter, and those conversations may later be opened (i.e. expanded) from the dock 102. Although a user may add and remove tasks to the workstation in a variety of manners for window organization known in the art today, the preferred mode of organization of a workstation is through the use of drag-and-drop technology. Drag-and-drop technology allows for ease of use and quick arrangement for a PC as well as any touch-based system. Any changes made to the workstation may be saved and associated with a unique user ID and password to allow for easy retrieval of the last state in which the Workstation existed.

A user may organize and manage tasks added to the workstation as the user engages in conversations via those tasks. The combination of multiple tasks allows the user to gain information, via posting questions or comments and reading other users' posts, on any particular combination of topics which might interest the user (e.g. news, updates, changes, upcoming events, etc.). The present invention further allows the user to take the information gained via the task(s) and act on an initial interest which led to the adding of the task or on a new interest resulting from newly obtained information from one or more tasks. Via the tag system, described in detail below, purchasable information, services, and/or goods relating to each task are made available to the user at the click of a button. For example, as shown in FIG. 1, a user may be interested in knowing more about Requests for Proposals (RFPs) coming from an agency network, so the user searches for and/or creates a conversation (task) discussing this issue. Assuming that a task on this topic has already been created, once the user finds the task (via browsing or searching) and reads through the existing conversation, the user realizes, from another user's comment, that a particular person should be contacted for the most accurate answer. The system or a moderator notes the tags associated with the task and scans its proprietary information database (e.g., tag database, or any other database) for purchasable content related to, or containing the same terms as, the tags associated with the task (in this example task, the tags are “Pepsi,” “RFP,” and “BBDO”). Once the task is added to the workstation, the user is offered an option to view all purchasable content matched with the task by clicking one button, the unlock button 208. The unlock button 208 opens an additional window (See FIG. 2) to provide the user with the various options of purchasable content. In this particular example, the user may purchase brand contact information 500 and/or agency contact information 501 (e.g., last name 503, email 504, phone number 505, etc.) for all persons or one specific person at the brand (Pepsi) or the agency (BBDO). The screenshot of FIG. 2 shows the information in a locked format, but clicking on the “Locked” button 502 allows the user to purchase any number of contacts, data, or products, either paying for those purchases or using any credits that the user might have. Using the system, a user is able to gain insight on a particular topic of interest and act on that interest (in this case, gaining insight by realizing the correct contact and acting by purchasing contact information for that person) on a single screen and on a single website. Thus, a user is able to both discover new brands and agencies to pitch and purchase the contact information to take the next step and act on those discoveries. The system provides an easy to use form where users can discuss industry happenings, view headlines of aggregated news, manage multiple conversations at once, and purchase information for an affordable fee or via trade and exchange, all without having to leave the screen or open a new webpage.

The page comprising the workstation, as well as other pages of the present invention, may further comprise a news feed 300 comprising a stream of currently available content that can be viewed and added by a user to the workstation at any time. In one embodiment, the news feed is comprised of blocks of news, where each block contains a single headline associated with a conversation, and where users can scroll through the news feed, either left or right, to view more results or wait for the feed to auto-scroll. The user may, upon hovering over a block of news, reveal the tags associated with the conversation and actionable features, such as viewing the conversation, adding the conversation to the workstation (i.e. creating a task), seeing related conversations, as well as unlocking (opening purchase options), sharing the conversation with other users, and following the conversation. The news feed 300 can include a wide variety of conversations through which the user may browse at his/her leisure. The news feed may be compiled using RSS feeds from any online source or database. For example, the news feed may be comprised of information from a database that automatically reports change. Such news on change engages users to comment, add their own data, and trigger other activities (e.g., purchasing of a product based on the change or the discussion of such change). If a user takes interest in a specific task or article on the news feed, the user may join the conversation (or start the conversation, if no other users have yet commented), which will then add that task to the user's workstation. The news feed can further comprise various arrangements of articles and information for a user to browse. These various arrangements are based on the tag system of the present invention and are described further below in the paragraphs relating to the tag system.

The workstation further comprises a search query box 400 for performing a manual search at any time to look for any number of tasks which may then be added to the workstation, if the user desires. Additionally, a user may click on a tag directly, as described below, which will add the term automatically to the search query box 400. A user may repeat this process in order to compile a set of search terms via existing tags.

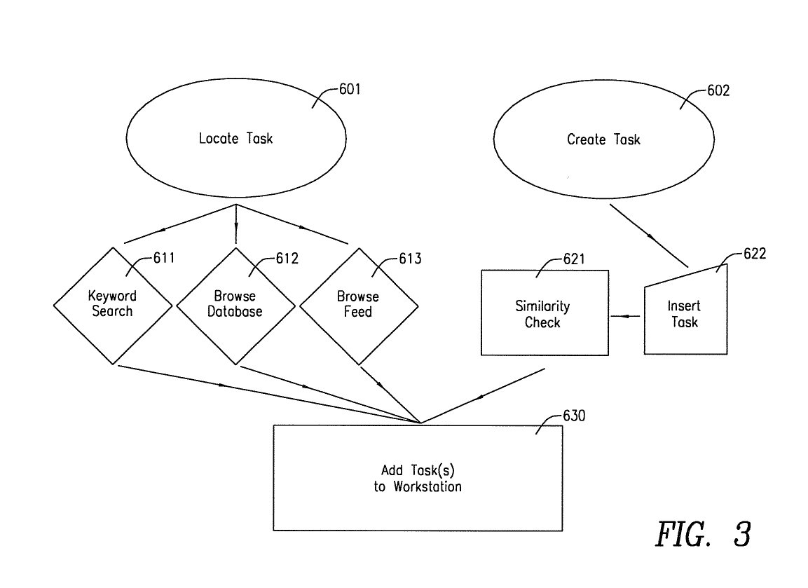

In order to form a workstation, a user must add and organize tasks. The addition of tasks may be performed in a variety of ways. FIG. 3 shows the steps that a user may take to add a new task to the workstation. This process may be performed an unlimited amount of times, allowing a user to build his/her workstation by finding conversations of interest and adding them as new tasks. In order to locate an existing task 601, a user may choose from several options. A user may perform a keyword search 611 through a database of preexisting tasks, entering keywords as input into the search query box 400 and receiving in return a list of results. A user may alternatively browse the database 612 without entering a keyword search term, instead sifting through conversations which are organized in a variety of manners (e.g., most current, most popular, suggested based on user preferences, etc.). A user may also browse the news feed 613, which similarly comprises preexisting conversations organized in a variety of manners. If the user cannot find a particularly helpful conversation, the user has the additional option of creating a new task 602 (also performed using the search query box 400). When a user initiates a new conversation by posting a question or comment, thus inserting the new conversation into the system 622, a primary check (i.e., a similarity check) 621 is performed against preexisting similar conversations. The similarity check is performed to show the user whether any helpful conversations may already exist, and to potentially avoid the requirement to create an entirely new task which may be redundant. The similarity check works, for example, by rendering a question to the system server and receiving an answer from the server. The server will find any conversations whose tags match some or all of the words used by the user in his/her search. If the answer matches the tags associated with the task, a similarity value is processed. If the match is not exact, i.e. there are differences between the tags associated with new task and the tags associated with existing tasks, the system determines that a new task will not be too similar to any existing task, potentially issuing an alert, as disclosed, e.g., in U.S. Pat. No. 8,161,064. The similarity check allows the user to create a new task while also viewing those tasks that might have some relationship to the new task but not complete similarity. Any similar tasks which are found are presented to the user, who may further decide to select any number of the available tasks to view. If no similar tasks currently exist, or if the user is unsatisfied with those tasks displayed by the similarity check, the user may decide to continue creating a new task. The user may, in addition to creating a new task, choose to add any preexisting tasks which are displayed as a result of the similarity check to their workstation. This similarity check, also referred to herein as a “Task Creation Redundancy Check,” greatly decreases the amount of duplicate and redundant tasks available to all users. Finally, however the user discovers or creates a new task, that task may be added 630 to the user's workstation if the user so desires. This step of adding the task may be performed, e.g., by dragging the conversation into the user's workstation. As a user manages his/her workstation, the tasks added and removed comprise those conversations which the user has either located or created, organized in a manner that allows the user to view multiple datasets of information at the same time.

In general, tasks are defined as any procedure or job that accommodates a single window (i.e., a part of a single screen). A task, for example, may take the form of a news article followed by input from various users in the form of comments and questions regarding the specific article (hereinafter referred to as “news conversations,” “news convos,” “article conversations,” or “article convos”). Article conversations are source created material, meaning that the conversation is initiated based on information arriving from a source other than a user (e.g., the program itself, third party news organizations, online feeds, etc.). Users may then contribute their thoughts and ideas on that article or other piece of information by posting questions, comments, or other messages within the conversation. A source created conversation may be established from any dataset from any database or RSS feed that could potentially illicit actions from users in the form of comments or responses in the form of a conversation thread. Tasks may also take the form of conversations and threads without an initial news article, initiated instead by a question or comment posted by a user (hereinafter referred to as “user conversations,” or “user convos”). User conversations are typically user created material, meaning that an initial topic is chosen and posted by a user, and then elaborated on by other users. Although the example of questions and answers is given herein, there is no limitation on the type of posts (initial and follow-up) that can be made. For example, users may share images, videos, etc., with the hope that other users will comment and contribute their thoughts and ideas based on the initial post or the associated thread of user input. Tasks are also tagged (i.e. identified by the common terms within the conversation) for the determination of their relevancy, or their lack of relevancy, with regard to a user's searching or browsing activity, and with regard to the purchase options offered to the user through the task.

Tasks may be inserted into the workstation and interacted with in a variety of manners by a user. For example, any user may further comment on the conversation within the task, thus growing the thread of the task. Due to the fact that multiple inputs may come from various users, the content that is added by each individual user can be rated 206 based on the comment's helpfulness. Each user may provide his/her rating on a post within a task, and an overall rating is constantly calculated by combining each individual user's rating of that post. The highest rated, and therefore the most helpful, post is highlighted and shown above all other responses within the task. Similar rating systems may be employed in other forms of tasks not limited to news conversations or user conversations. It should also be noted that each task has its own unique ID, similar to that disclosed in U.S. Pat. No. 7,424,471, in the database, to which all connected data (e.g., comments, tags, branches, ratings, purchase options, etc.) can be related through a server query.

Once a task has been added to the workstation, a secondary access point to the task is created, herein referred to as a tab 104. A tab is a single conversation condensed into its simplest form—tags and a shortened subject to identify the conversation. Tabbed conversations share the same features as their larger counterparts (i.e. open conversations). Tabs are further held within a tiered, color-coded, organizational index, herein referred to as a dock 102. Preferably, two tiers exist within the dock (there is no limit on the amount of tiers, however), with the upper tier holding tabs associated with tasks that the user deems as “important.” Such important tasks act exactly the same and share the same features and abilities as all other tasks (i.e., default tasks), the only difference being that their tabs are located one tier higher than the tabs for tasks not labeled as important. Assigning importance to a task allows the user to separate numerous tasks into those they are actively engaged in and those which they wish to personally keep an eye on without the need for constant attention. A user has complete control over whether a task is important to them or not and which tier to place that task in. The user may also adjust the importance associated with a task at any time. There may, however, be times where direct placement of a task (as important or default) can occur. For example, a purposeful personal search query could be deemed important, as the user is actively searching for a particular task. A random news feed article, on the other hand, could be deemed as default, since the user was just browsing. Using similar logic, Preferred topics, when activated, could be directed automatically to the important tier, while Suggested topics would be directed automatically to the default tier (see further below for discussion of Preferred and Suggested conversations). Such variances can be decided and utilized based on the individual user's tag preferences, which are adjustable within the user settings of the present invention. The dock and the workstation correspond with one another with regard to task importance; i.e., if a task is labeled as important in the workstation, the dock will reflect that same change for the associated task, and vice versa. The dock also adds to the organizational structure of the present invention by providing remote access to task features without requiring a user, who may have many tasks open, to scroll through the workstation. In some embodiments, a tab may become highlighted to notify the user that new activity has occurred since the user last viewed the conversation.

Additionally, in some embodiments, a mass index menu 106 allows a user to perform an operation on multiple tasks simultaneously. Operations will alter depending on the task. For example, news convos or user convos, in combination, can be shared with other users, removed from the workstation, selected for an alert mechanism, and searched for tags.

Tags

Each task is associated with a set of identifiers known as tags 202, which identify the basic subject and common terms of a task. Tags also allow for categorization of a given task with related or similar tasks, or conversations, and the association of purchase options with a task. Tags comprise terms commonly used within a specific task, and they create identifiers to cluster either individual comments or entire tasks by relevancy. A user may personally insert specific tags in the user preferences/settings of his/her account in order to receive suggestions for additional conversations to add to the workstation which contain those tags inserted by the user. The system of the present invention will also programmatically note and record the tags associated with the tasks in a user's workstation. It should be noted, also, that any information in the workstation, including but not limited to tags, can be gathered and related to the task as it is being rendered on a user's page. Thus, a user has the option to create his/her own set of preferred tags and/or allow the system to create a set of user-preferred tags based on the user's activity. A user can also assign tags to those tasks which he/she creates. While a user may not add or remove tags to/from an existing task, a moderator of the system (e.g., a system operator) may edit any tag on any task at any time. Additionally, a human (either user or moderator) may not be required at all to add, remove, or change tags associated with a given task. Instead, the source of a source-created conversation may provide appropriate tags, such that the task will already be associated with tags once it reaches the presently claimed system as a conversation. Alternatively, an algorithm or program (based on, e.g., a character search) can be assigned to double-check, suggest, and/or assign tags for any task. Once a list of tags is compiled, using any or all of the methods described herein, the system assigns appropriate jobs based on the tags collected. Jobs include, but are not limited to, targeted advertising, suggested and preferred tasks, direct purchasing options, and other suggestions or options based on the user's actions and preferences. Tags essentially bring data into focus and relevancy, and if the data revealed by a task's activity (i.e. the conversation associated with that task) is desirable to the user, the user has the option to trigger a command, located on the same page, which facilitates the purchase or acquisition of goods, services, and/or information having, due to the system of tags, a meaningful relationship to that task.

Tags may be arranged and utilized to indicate, in various fashions, those tasks which are most relevant/important in any pattern, order, or configuration acceptable to a user. Tags may be used as keywords when a user searches for a new conversation to view and/or add to the workstation. Additionally, tags acquired from tasks already existing on a given user's workstation may be utilized to target related content (e.g., for marketing purposes) or point to related directly purchasable goods (i.e., a desired result/solution of the user-created workstation). Purchasing options are created for each individual user, for example, by prompting the user with a field of questions and/or multiple choice answers, setting up the ability for the user to purchase or request a specific product or result. There is no limitation on the purchase options available to an individual using the present system.

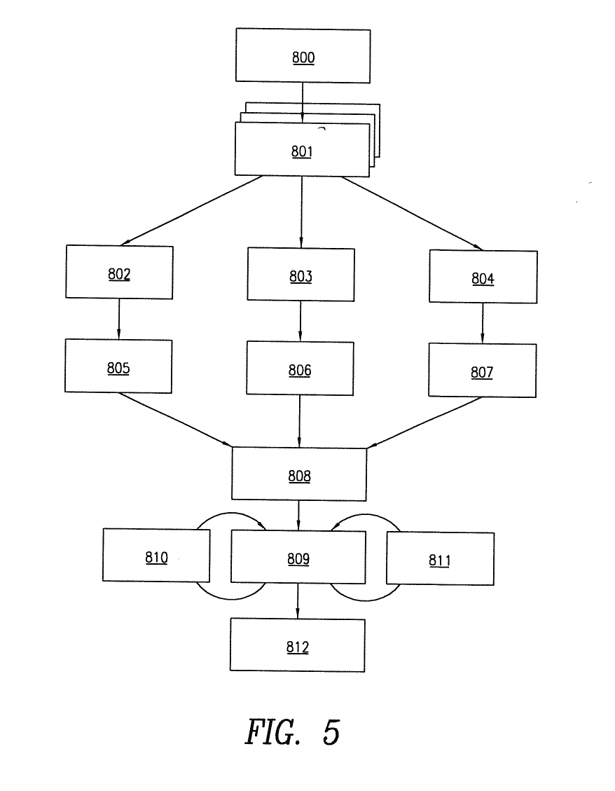

FIG. 5 illustrates the steps of the process for associating purchase options with a task by utilizing the tag system. Every task 800 of the presently claimed invention is identified via one or more common terms, referred to as tags 801. In the example in FIG. 5, there are three tags associated with the given task. Each tag is then taken individually 802, 803, 804 and purchase options are compiled separately based on the information from each individual tag 805, 806, 807. Once various purchase options have been identified for each tag individually, the purchase options are combined 808, forming a set of aggregated purchase options for the task. The aggregated purchase options are then stored within a relevancy indexing unit 809. The relevancy indexing unit 809 continuously receives updated information regarding a user's preferences which are based on the tags associated with that user. The tags associated with a user are either those tags which the user inputs himself as personally preferred tags 810 or the tags associated with the tasks located within the user's workstation 811. Thus, as a user continues searching, browsing, commenting, and managing tasks, the indexing unit 809 receives tag information based on user activity and continuously updates the running list of potential purchase options in order of relevance to that particular user. When a user decides to unlock the list of purchase options available (e.g., by clicking the lock button), the indexing unit is able to display to the user the list of purchasing options available in order of relevancy 812. The user may then act upon any information he/she derived from the plurality of managed tasks by deciding to purchase one or more of the options provided via the system.

As mentioned above, the tag system is also used to create various arrangements within the news feed 300. The news feed may display the current news (Current), which simply displays anything in the news at the present time. This aspect is the simplest of the convo arrangements formed by the present system, and rather than being based on the tag system, it is based on time, with the feed being updated automatically and constantly as new conversations are created. Scrolling reveals previously created conversations in order of creation. The news feed may alternatively display tags by their popularity (Trending). This portion comprises a list of those tags which are most commonly used by all users and across all conversations on the platform (i.e., the user is able to see the most popular tags based on how many conversations an individual task is associated with). Thus, if a user wants to find the most popular topics being discussed, that user may choose to view the “Trending” portion of the news feed, and instead of browsing through conversations, the user may browse through commonly used tags and the conversations with which those tags are associated. Additional portions of the news feed include a “Preferred Convos” portion and a “Suggested Convos” portion. Preferred Convos are organized by the system to offer certain conversations in line with a given user's personal preferences (i.e., those tags which a user entered him/herself, at the Settings/User Preferences page). Suggested Convos are organized by the system to offer certain conversations in line with tags matching what the user currently has active in his/her workstation. Although Preferred and Suggested Convos will sometimes correspond with one another, Suggested Convos offer a wider approach and will incorporate information that might be slightly less related (or slightly off topic) but still of potential interest to the user.

Branching

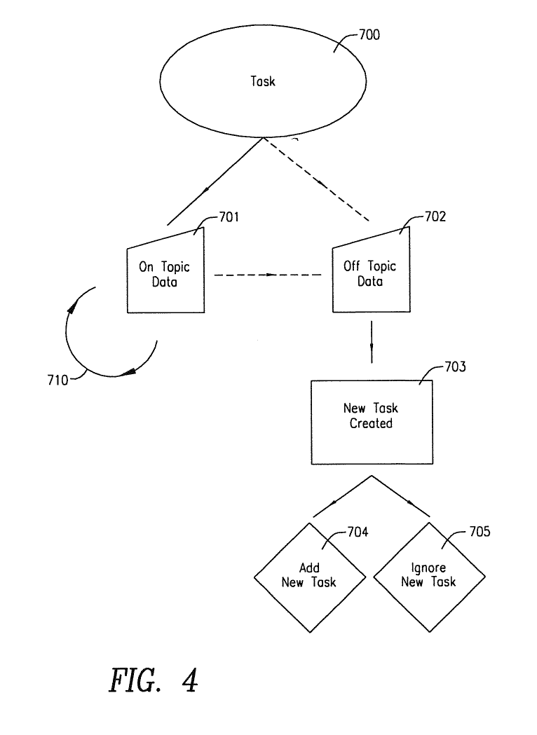

In some cases, an otherwise undisturbed piece of data may be added to a task (e.g., a new comment or question is posted by any user using the system) which is off topic to a certain threshold degree. Due to its being off topic, this piece of data would alter or add one or more tags associated with the task (as determined by a moderator or programmatically). When this occurs and/or is noticed by the system moderator or the program itself, the off topic piece of data is transformed into a separate and unique task (although perhaps still somewhat related to the original task), accessible both through the original task as well as through a general search. This transformation is referred to herein as branching 204. FIG. 4 details the steps taken in the branching process in order to determine whether newly posted data will remain within a given task or be separated into a new task. Specifically, new data is continuously added by a variety of users into a particular task 700. The new data may be categorized as either on-topic data 701 or off-topic data 702. All new data is initially presumed to be on-topic data. A verification step 710 is then performed to confirm that the new data is on-topic, in which case the data remains a part of the existing task to which it was posted. This verification step 710 is similarly performed by either the system moderator or programmatically using an algorithm. In certain embodiments, this verification step for determining whether new data is off topic comprises comparing the common term(s) or subject of the newly posted data with the tags associated with the task in which the new data was posted. If the common term(s) or subject of the new data matches (i.e. does not alter) the tags associated with the task, the new data is deemed to be on topic. If the new data would alter the tags associated with the task, the new data is deemed to be off topic. Such categorization may be performed by a system moderator or by the program itself using an algorithm. If the new data does not pass the verification step 710, the new data is deemed to be off-topic data 702. Any such off-topic data then initiates the creation of a new task 703. Finally, the user is informed of the new task creation and has the option to add the new task to the workstation 704 or to ignore the new task (i.e., not to add the task to the workstation) 705.

Branching can be performed by a moderator of the system who reviews the tags associated with tasks. It can also be performed programmatically without human intervention by employing an algorithm for character searching or the like. For example, a task may comprise a conversation started by a user posting a comment about Pepsi at their agency (“the agency”). Tags are associated with this new conversation, such as, e.g., “Pepsi” and “the agency.” The next comment posted to this conversation is provided by a second user who asks about other brands handled by the same agency. Although not focusing on Pepsi, this comment may not significantly alter or add a tag to the task, and thus the comment remains associated with this conversation (i.e., a new conversation is not yet needed or formed). Then, a third user asks if anyone has heard about requests for proposals in the beverage industry in general. This question poses a much broader issue, which will likely receive responses which will be associated with tags which deviate from the original tags of “Pepsi” and “the agency.” Thus, rather than losing track of the original topic and task, a separate conversation is initiated, branching from the original conversation. In this manner, the contributions to a given discussion, or task, remain on topic such that a user does not have to peruse through a plurality of off-topic comments. However, if a user desires, the off-topic information is available to him/her at the push of one button. A user is able to access the new conversation by linking to it from the original conversation via the branch button 204, or alternatively, the user may search for the new conversation using any of the other methods described herein. Thus, branching offers an additional form of organization to users in that unrelated content is not hidden inside a task containing other content, and while being accessible through that task, the unrelated content is marked by a branch button. By separating off-topic ideas, both users and servers are able to quickly, and more easily, find and distinguish conversations of interest which are directly on point. Unlike most conversation threads today, which become cluttered with irrelevant topics and deleted posts, branching gives users the ability to take action within the newly formed topic without disrupting or having to leave the current task or conversation.

In addition to branching, the task management system, method, and device disclosed herein may further comprise a search software module that allows the user to create custom searches of theoretically any network accessible data set and to save and associate those searches with a unique identifier for easy reference. This additional method is further disclosed in U.S. Pat. No. 7,424,471, which is incorporated fully by reference herein. Searches saved using this method are also portable.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

What is claimed is:

1. A system for linking conversations to purchase options using common term identifiers, comprising one or more processing units configured to:
collect conversations, said conversations comprising a plurality of posts,
assign one or more tags to each conversation, said tags being based on common terms in the conversation,
display user-chosen conversations in a single workspace,
maintain a user-specific set of tags based on said user-chosen conversations in said single workspace, and
associate one or more purchase options with each conversation, said purchase options being based on said one or more tags assigned to the conversation, wherein said purchase options are presented to a user and are directly accessible by the user via said workspace.

2. The system of claim 1, further comprising one or more processing units configured to form a new conversation sourced from an off topic post to an existing conversation.

3. The system of claim 1, wherein said purchase options are presented to the user in an order of relevancy based on a combination of tags associated with one or more conversations displayed in the user's workspace.

4. The system of claim 3, wherein said order of relevancy is further based on the user's manually input preferences.

5. The system of claim 1, wherein the system is moderated by a human.

6. The system of claim 1, wherein the system is moderated without human intervention.

7. The system of claim 1, wherein the user-chosen conversations are located via browsing.

8. The system of claim 1, wherein the user-chosen conversations are located via character searching.

9. The system of claim 1, wherein the purchase options comprise proprietary contact information.

10. The system of claim 1, wherein the purchase options comprise goods.

11. The system of claim 1, wherein the purchase options comprise services.

12. The system of claim 1, further comprising one or more processing units configured to create a new conversation and perform a similarity check.

13. The system of claim 1, wherein conversations are grouped based on tags.

14. The system of claim 1, further comprising one or more processing units configured to suggest conversations to a user based on a combination of tags associated with the user's workspace.

15. The system of claim 1, wherein each post is rated based on veracity.

16. The system of claim 1, wherein one or more conversations are collapsed into one or more tabs.

17. A system for managing multiple conversations, comprising:
a user interface for displaying all conversations from one or more conversation databases, said user interface further comprising a workspace for organizing user-chosen conversations, wherein each user-chosen conversation is labeled with one or more common terms within said user-chosen conversation, said common terms forming one or more tags,
a tag database for storing one or more common terms associated with a particular conversation, said tag database further comprising one or more purchase option datasets based on an individual tag and associated with said particular conversation,
wherein the user interface, upon a user's initiation, further displays a list of purchase options compiled from said tag database and associated with the one or more tags of a user-chosen conversation.

18. The system of claim 17, wherein said user interface groups user-chosen conversations by importance to a user.

19. The system of claim 17, wherein said user interface further comprises one or more unlock buttons for displaying the list of purchase options.

20. A social network method for managing multiple datasets and offering purchase options to a user, comprising,
identifying one or more common terms within each dataset stored in a database, creating an association between said terms and said dataset,
performing a search through a purchase database to identify purchase options for a particular dataset based on the dataset's associated common terms, linking said purchase options with said particular dataset,
displaying to a user all existing datasets, wherein said user chooses one or more datasets to follow and interact with,
relocating one or more user-chosen datasets into a reorganizable workspace, and
providing the user, upon user request, with a plurality of purchase options linked with each user-chosen dataset.
